(19) United States
(12) Patent Application Publication
(10) Pub. No.: US 2014/0152231 A1
(43) Pub. Date: Jun. 5, 2014

(54) Dolly Charger

(71) Applicant: Pao-Feng Li, Taipei (TW)

(72) Inventor: Pao-Feng Li, Taipei (TW)

(21) Appl. No.: 13/689,771

(22) Filed: Nov. 30, 2012

(51) Int. Cl. H02J 7/00

(52) U.S. Cl. CPC H02J 7/0044; H02J 7/0054; Y02E 60/12
USPC 320/103

(57) ABSTRACT

This present invention provides a compact and portable dolly charger with amusing appearance, particularly for use outdoors. It has the following features; an interesting and specific pattern of appearance, a doll body having a major accommodating space and a secondary accommodating space, a charging socket located across the major accommodating space and the surface of the doll body for fitting of a power line to a portable electronic device, a modular battery box located in the secondary accommodating space and electrically connected to the charging socket and a printed circuit board, a printed circuit board electrically connected to the charging socket and capable of outputting the electric power of the modular battery box to a portable electronic device via the charging socket and a power line, the secondary accommodating space having an opening for installing the modular battery box and a capping plate for closing the opening.

### FIELD OF THE INVENTION

This present invention relates to the field of design, pattern, and assembly of a charger with a dolly appearance.

### BACKGROUND OF THE INVENTION

Due to the rapid development of the electronic and information industries, the portable electronic devices have almost become indispensable to all of us, such as mobile phones, walk-man CD players, tablet personal computers, and digital cameras those are using a rechargeable battery as their power supply. Users have to frequently check the remaining power supply, in order to use them any time when needed. There is an inconvenience of recharging the portable electronic products outdoors. In the case of using a mobile phone outdoors, the mobile phone will shut down, if it runs out of the battery power. Ordinary batteries can not be installed in a mobile phone.

### SUMMARY OF THE INVENTION

This present invention provides a compact and portable dolly charger with amusing appearance, particularly for use outdoors. It has the following features; an interesting and specific pattern of appearance, a doll body having a major accommodating space and a secondary accommodating space, a charging socket located across the major accommodating space and the surface of the doll body for fitting of a power line to a portable electronic device, a battery box located in the secondary accommodating space and electrically connected to the charging socket and a printed circuit board, a printed circuit board electrically connected to the charging socket and capable of outputting the electric power of the battery box to a portable electronic device via the charging socket and a power line, the secondary accommodating space having an opening for installing the battery box and a capping plate for closing the opening.

The battery box has the following components; a frame comprising a top cap and two first supporting walls, a bottom seat having a second supporting wall capable of snapping with the first supporting walls and having first, secondary, third containing rooms for putting batteries between the first supporting walls and the second supporting wall, a positive pole mounted on the top surface of the top cap, a negative pole mounted on the top surface of the top cap adjacent to the positive pole, a first conducting part mounted on the bottom surface of the top cap and corresponding to the first containing room, a second conducting part mounted on the bottom seat and having two terminals corresponding to the first and third containing rooms respectively, a third conducting part mounted on the bottom surface of the top cap and having two terminals corresponding to the second and third containing rooms respectively, and a fourth conducting part having two terminals that one is mounted on the top cap and connected with the negative pole, another is mounted on the bottom seat and corresponding to the second containing room.

### BRIEF DESCRIPTION OF THE DRAWINGS

FIG. 1 is a combined three-dimensional illustration of the first embodiment.

FIG. 2 is a separated three-dimensional illustration of the first embodiment.

FIG. 3 is a separated three-dimensional illustration of the battery box.

FIG. 4 is a bottom cross-section view of the battery box.

FIG. 5 is a combined three-dimensional illustration of the second embodiment.

FIG. 6 is a perspective view of the doll body in FIG. 5.

FIG. 7 is a combined three-dimensional illustration of the third embodiment.

FIG. 8 is a perspective view of the doll body in FIG. 7.

FIG. 9 is a combined three-dimensional illustration of the fourth embodiment.

FIG. 10 is a perspective view of the doll body in FIG. 9.

FIG. 11 is an illustration of light emitting diodes and switch button of the doll body.

### DETAILED DESCRIPTION OF THE PREFERRED EMBODIMENTS

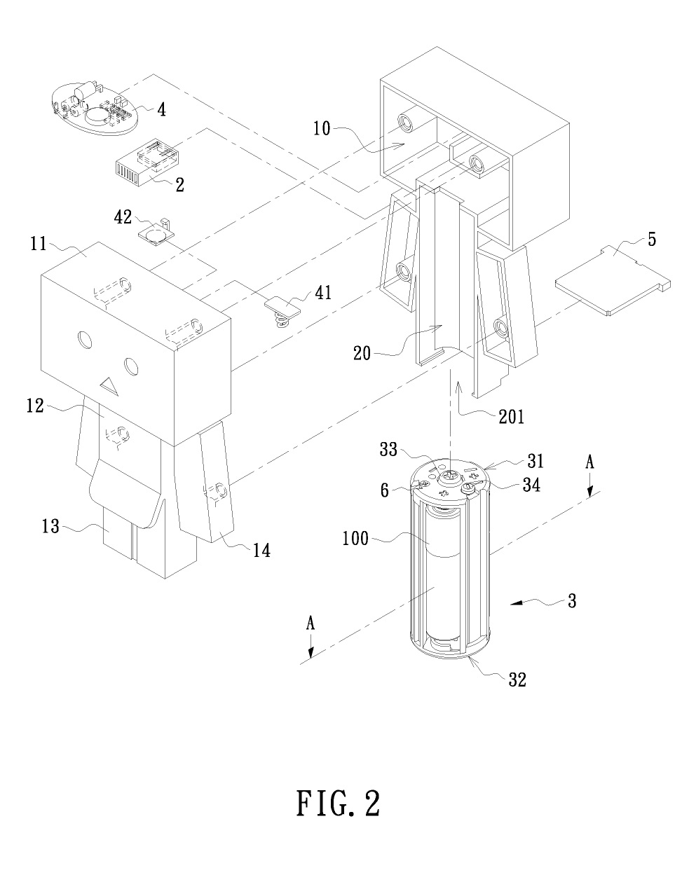

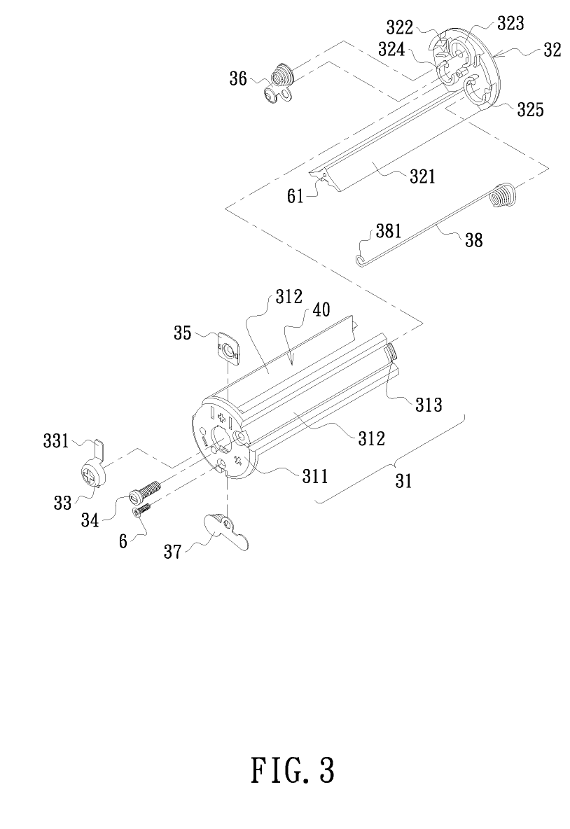

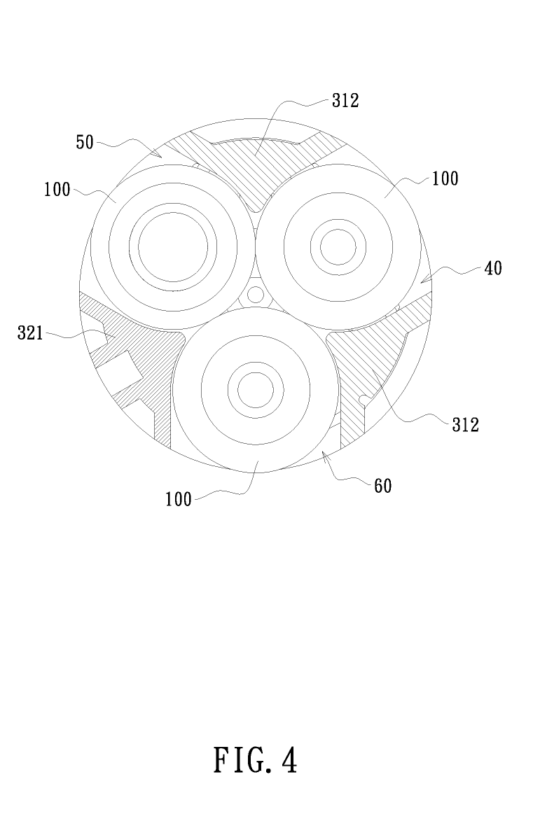

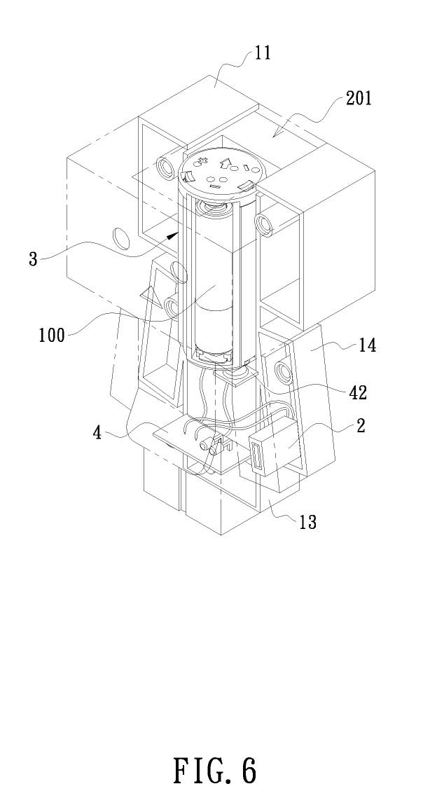

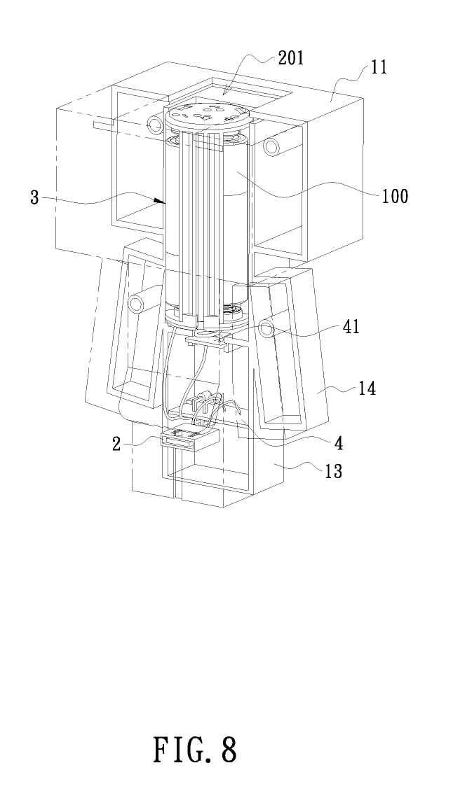

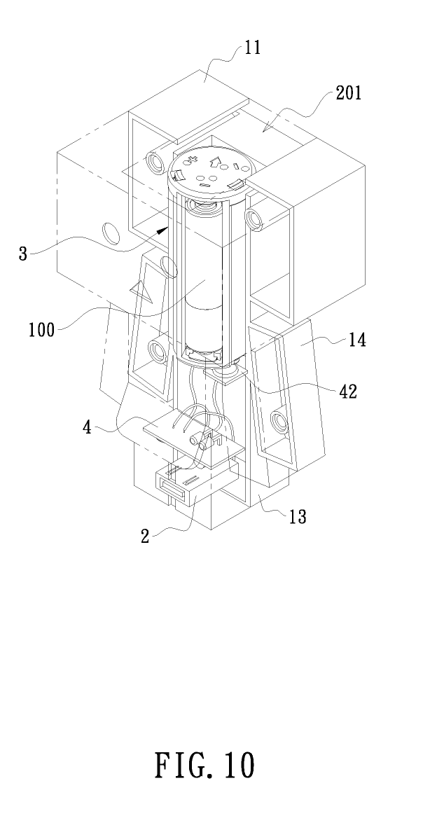

As shown in FIGS. 2-4, 6, 8, 10, this invention discloses a dolly charger that comprises the following components and features.

A doll body (1) has a pattern of appearance, a major accommodating space (10), and a secondary accommodating space (20). The secondary accommodating space (20) has an opening (201) for installing a battery box (3) and a capping plate (5) for closing the opening (201).

A charging socket (2) is mounted across the major accommodating space (10) and the surface of the doll body (1) for fitting of a power line to a portable electronic device (30).

A printed circuit board (4) has positive and negative connecting tabs (41, 42) those are intended to respectively contact positive pole (33) and negative pole (34) of the battery box (3). The printed circuit board (4) is electrically connected to the charging socket (2) and capable of outputting the electric power of the battery box (3) to a portable electronic device (30) via the charging socket (2) and a power line.

The battery box (3), that is located in the secondary accommodating space (20) and electrically connected to the printed circuit board (4) and the charging socket (2), further has a frame (31) comprising a top cap (311) and two first supporting walls (312), a bottom seat (32) having a second supporting wall (321), capable of snapping with the first supporting walls (312), and having first, secondary, third containing rooms (40, 50, 60) for putting batteries (100) between the first supporting walls (312) and the second supporting wall (321), a positive pole (33) mounted on the top surface of the top cap (311), a negative pole (34) mounted on the top surface of the top cap (311), adjacent to the positive pole (33), a first conducting part (35) mounted on the bottom surface of the top cap (311) and corresponding to the first containing room (40), a second conducting part (36) mounted on the bottom seat (32) and having two terminals corresponding to the first and third containing rooms (40, 60) respectively, a third conducting part (37) mounted on the bottom surface of the top cap (311) and having two terminals corresponding to the second and third containing rooms (50, 60) respectively, and a fourth conducting part (38) having two terminals that one is mounted on the top cap (311) and connected with the negative pole (34), another is mounted on the bottom seat (32) and corresponding to the second containing room (50).

The doll body (1) comprises a head (11), an upper body (12), a lower body (13), and two arms (14). The charging socket (2) can be mounted on the head (11), the upper body (12), the lower body (13), or the arm (14) of the doll body (1) for customer's choice. The battery box (3) is easily exchanged or replaced because of the convenience from the major accommodating space (10) and the secondary accommodating space (20).

The bottom seat (32) has a snap fastener (322) for snapping with a snap hook (313) of the first supporting wall (312). The bottom seat (32) further has a first positioning groove (323) corresponding to one terminal of the second conducting part (36), a second positioning groove (324) corresponding to another terminal of the second conducting part (36), and a third positioning groove (325) corresponding to one terminal of the fourth conducting part (38). By means of the second conducting part (36), the fourth conducting part (38), the snap fastener (322), the snap hook (313), the first positioning groove (323), the second positioning groove (324), and the third positioning groove (325), the battery box (3) can be prevented from a power disconnection due to any loose connection between batteries and conducting parts.

The positive pole (33) has a thin slice (331) going through the top cap (311) and being fixed by the first conducting part (35); and the negative pole (34) is screwed onto the top cap (311), connects with a hooking loop (381) of the fourth conducting part (38), and fix the hooking loop (381) onto the top cap (311). By connection of the negative pole (34) and the hooking loop (381), the fourth conducting part (38) is firmly fixed between the top cap (311) and the negative pole (34), and help disposing the batteries (100) well. The printed circuit board (4) has the positive and negative connecting tabs (41, 42) for the battery box (3), and is capable of outputting the electric power of the battery box (3) to a portable electronic device (30) via the charging socket (2) and a power line.

The second supporting wall (321) has a screw hole (61) and a screw nut (6) those can connect and fix the second supporting wall (321) and the frame (31). By connection of the screw nut (6) and the screw hole (61), the battery box (3) can be prevented from a power disconnection due to any loose connection between batteries and conducting parts.

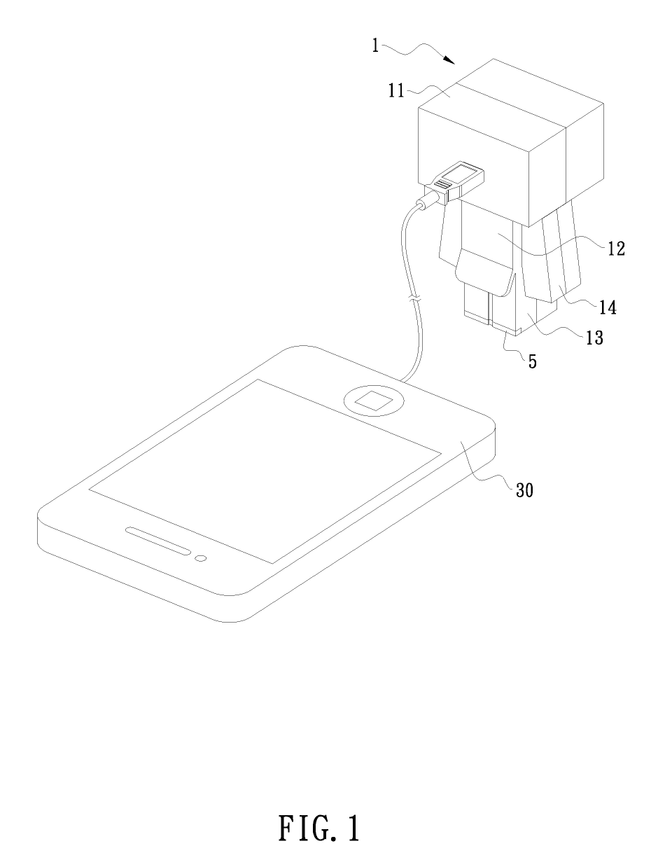

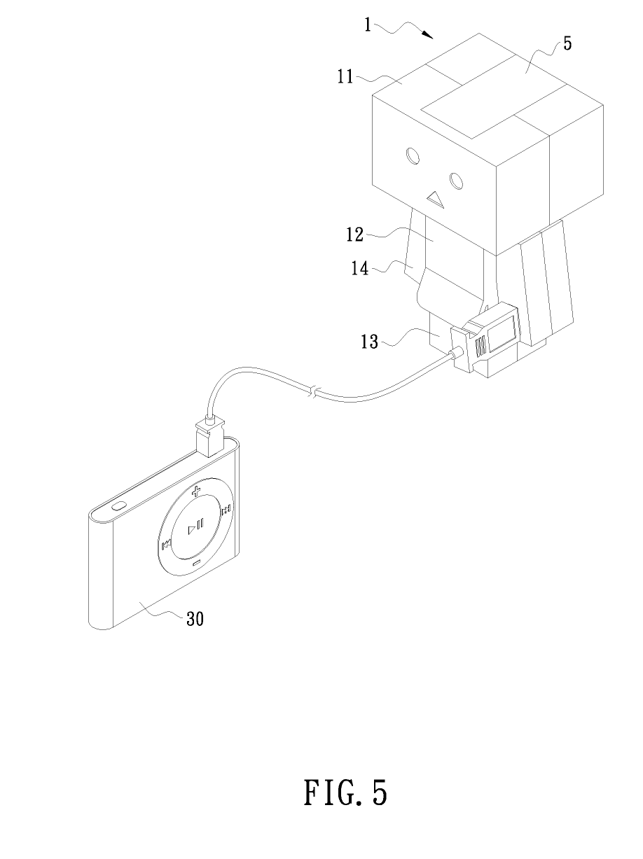

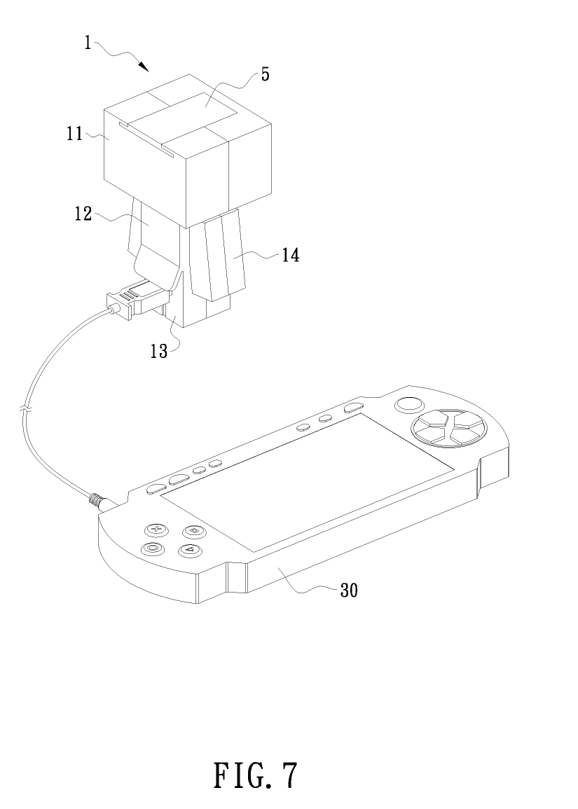

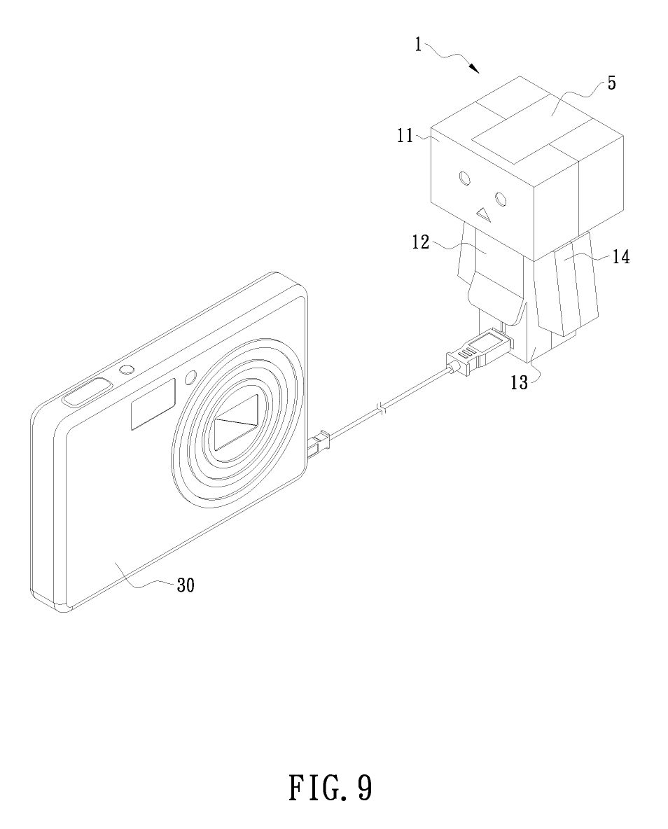

Furthermore, FIG. 1 is a combined three-dimensional illustration of the first embodiment. FIG. 5 is a combined three-dimensional illustration of the second embodiment. FIG. 7 is a combined three-dimensional illustration of the third embodiment. FIG. 9 is a combined three-dimensional illustration of the fourth embodiment. In the above figures, the portable electronic device (30) is one of the following devices: a mobile phone, a smart phone, a notebook computer, a tablet personal computer, a compact digital camera, a personal digital assistant, a music player, and a video game console. The charging socket (2) is one of the following types: USB, Micro USB, Mini USB, 2.5 mm socket, and 3.5 mm socket, to be taken into consideration with the specifications of the portable electronic device (30) and the power line.

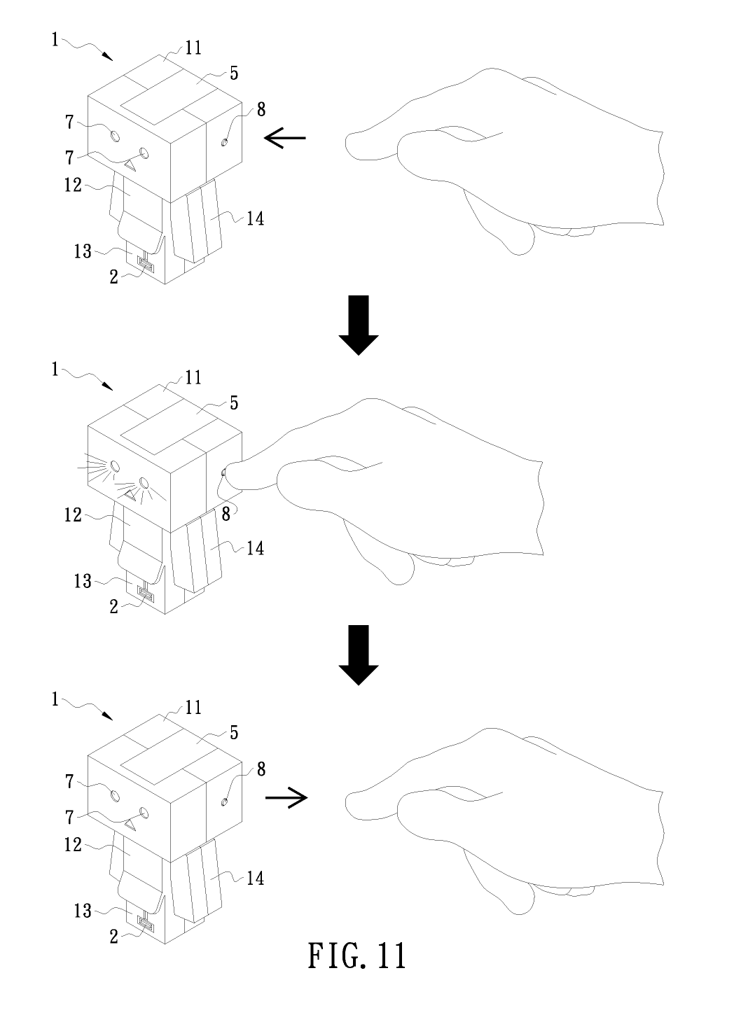

As shown in FIG. 11, light emitting diodes (7) are mounted in the doll body (1) and controlled by a switch button (8) that is also mounted in the doll body (1). The light emitting diodes (7) can make the doll body (1) to be used as a flashlight, a laser pointer, or a detector for counterfeit bills.

By means of the dolly charger disclosed by this invention can recharge the portable electronic devices anytime outdoors or in case of a power failure in buildings. The doll body can also be made with a variety of amusing patterns such as cartoon figures, object models, transportation equipment, sporting goods, fruit models. The battery box is a compact and firm assembly for easy and quick installation, so as to be prevented from a power disconnection due to any loose connection between batteries and conducting parts.

The scope of this invention is not limited to the illustrated practices. This invention is not to be taken as limited to all of the details thereof, as modifications and variations thereof may be made with the scope or spirit of this invention.

1. A dolly charger comprises:
a) a doll body (1) having a pattern of appearance, a major accommodating space (10), and a secondary accommodating space (20), and wherein the secondary accommodating space (20) has an opening (201) for installing a battery box (3) and a capping plate (5) for closing the opening (201);
b) a charging socket (2) mounted across the major accommodating space (10) and the surface of the doll body (1) for fitting of a power line to a portable electronic device (30);
c) a printed circuit board (4) having positive and negative connecting tabs (41, 42) for the battery box (3), electrically connected to the charging socket (2), and capable of outputting the electric power of the battery box (3) to a portable electronic device (30) via the charging socket (2) and a power line; and
d) wherein the battery box (3), that is located in the secondary accommodating space (20) and electrically connected to the printed circuit board (4) and the charging socket (2), further has
i) a frame (31) comprising a top cap (311) and two first supporting walls (312),
ii) a bottom seat (32) having a second supporting wall (321), capable of snapping with the first supporting walls (312), and having first, secondary, third containing rooms (40, 50, 60) for putting batteries (100) between the first supporting walls (312) and the second supporting wall (321),
iii) a positive pole (33) mounted on the top surface of the top cap (311),
iv) a negative pole (34) mounted on the top surface of the top cap (311), adjacent to the positive pole (33), but not electrically connected with the positive pole (33),
v) a first conducting part (35) mounted on the bottom surface of the top cap (311) and corresponding to the first containing room (40),
vi) a second conducting part (36) mounted on the bottom seat (32) and having two terminals corresponding to the first and third containing rooms (40, 60) respectively,
vii) a third conducting part (37) mounted on the bottom surface of the top cap (311) and having two terminals corresponding to the second and third containing rooms (50, 60) respectively, and
viii) a fourth conducting part (38) having two terminals that one is mounted on the top cap (311) and connected with the negative pole (34), another is mounted on the bottom seat (32) and corresponding to the second containing room (50).

2. The dolly charger of claim 1,
a) wherein the doll body (1) comprises a head (11), an upper body (12), a lower body (13), and two arms (14); and
b) wherein the charging socket (2) can be mounted on the head (11), the upper body (12), the lower body (13), or the arm (14).

3. The dolly charger of claim 1,
a) wherein the bottom seat (32) has a snap fastener (322) for snapping with a snap hook (313) of the first supporting wall (312); and
b) wherein the bottom seat (32) further has
i) a first positioning groove (323) corresponding to one terminal of the second conducting part (36),
ii) a second positioning groove (324) corresponding to another terminal of the second conducting part (36), and
iii) a third positioning groove (325) corresponding to one terminal of the fourth conducting part (38).

4. The dolly charger of claim 1,
a) wherein the positive pole (33) has a thin slice (331) going through the top cap (311) and being fixed by the first conducting part (35); and
b) wherein the negative pole (34) is screwed onto the top cap (311), connects with a hooking loop (381) of the fourth conducting part (38), and fix the hooking loop (381) onto the top cap (311).

5. The dolly charger of claim 1, wherein the second supporting wall (321) has a screw hole (61) and a screw nut (6) those can connect and fix the second supporting wall (321) and the frame (31).

6. The dolly charger of claim 1, wherein the doll body (1) has mounting of light emitting diodes (7) controlled by a switch button (8).
